(19) United States
(12) Patent Application Publication
(10) Pub. No.: US 2009/0212186 A1
(43) Pub. Date: Aug. 27, 2009

(54) HOOK DEVICE WITH A DECORATIVE PANEL

(76) Inventor: Sam S. Wang, Yun-Lin Hsien (TW)

Correspondence Address: DLA PIPER LLP (US ), 2000 UNIVERSITY AVENUE, EAST PALO ALTO, CA, 94303-2248, US

(21) Appl. No.: 12/036,131

(22) Filed: Feb. 22, 2008

(51) Int. Cl. F16B 45/00; A47G 1/20

(52) U.S. Cl. 248/304; 248/227.1; 248/339

(57) ABSTRACT

A hook device includes a hook body, a decorative panel, and a retaining frame. The hook body has a wall mounting portion that has a front mounting surface and a lower end, and a hook portion that extends from the lower end of the wall mounting portion. The decorative panel is disposed on the front mounting surface, and has a decorative picture and a transparent face plate through which the decorative picture can be viewed. The retaining frame is mounted on the wall mounting portion, and has an opening through which the decorative panel can be viewed, and an outer rim capable of securing the decorative panel on the hook body.

### BACKGROUND OF THE INVENTION

1. Field of the Invention

This invention relates to a hook device, more particularly to a hook device with a decorative panel.

2. Description of the Related Art

Referring to FIG. 1, a conventional hook device 10 comprises a hook body 11 and a decorative frame 12. The hook body 11 has a wall mounting portion 111 and a hook portion 112 extending from a lower part of the wall mounting portion 111. A back side of the wall mounting portion 111 is adapted for adhering to a wall, and the hook portion 112 is adapted for hanging articles. The decorative frame 12 has a color that is different from that of the hook body 11, and an outer rim 121 capable of mounting the decorative frame 12 on the wall mounting portion 111 of the hook body 11. The decorative frame 12 has a plurality of openings 122, through which the color of the hook body 11 can be viewed, thus achieving a decorative effect.

Although the conventional hook device 10 achieves a decorative effect, there is a need to further improve the versatility of the decorative function and the way in which the decorative frame 12 is mounted on the hook body 11.

### SUMMARY OF THE INVENTION

Therefore, the object of the present invention is to provide a hook device capable of providing a greater variety of decorative effects and an enhanced outer appearance.

According to the present invention, there is provided a hook device comprising a hook body, a decorative panel, and a retaining frame. The hook body has a wall mounting portion that has a front mounting surface and a lower end, and a hook portion that extends from the lower end of the wall mounting portion. The decorative panel is disposed on the front mounting surface, and has a decorative picture and a transparent face plate through which the decorative picture can be viewed. The retaining frame is mounted on the wall mounting portion, and has an opening through which the decorative panel can be viewed, and an outer rim capable of securing the decorative panel on the hook body.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional hook device;

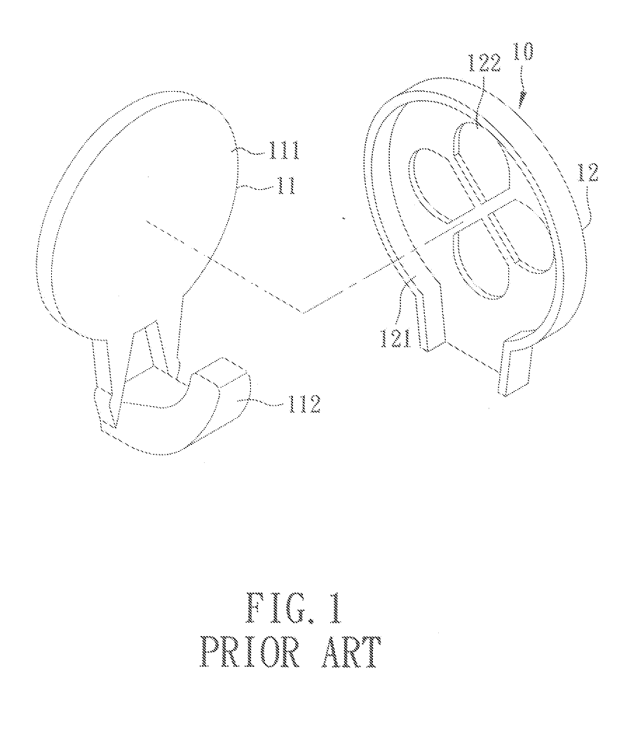

FIG. 2 is a front perspective view of a preferred embodiment of a hook device according to this invention;

FIG. 3 is an exploded perspective view of the hook device of FIG. 2;

FIG. 4 is a sectional view of the preferred embodiment of a hook device according to this invention;

FIG. 5 is a cross-sectional view of the hook device, taken along line V-V in FIG. 4;

FIG. 6 is a cross-sectional view of the hook device, taken along line VI-VI in FIG. 4;

FIG. 7 is a sectional view of the preferred embodiment in a state mounted on a wall; and

FIG. 8 is a schematic view illustrating how a picture created by a user can be sized for placement in the preferred embodiment of a hook device according to this invention.

### DETAILED DESCRIPTION OF THE PREFERRED EMBODIMENT

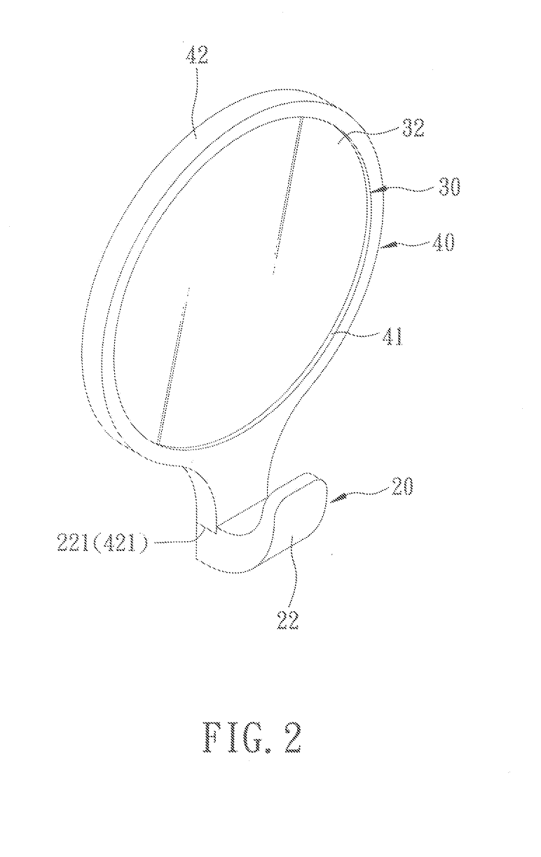

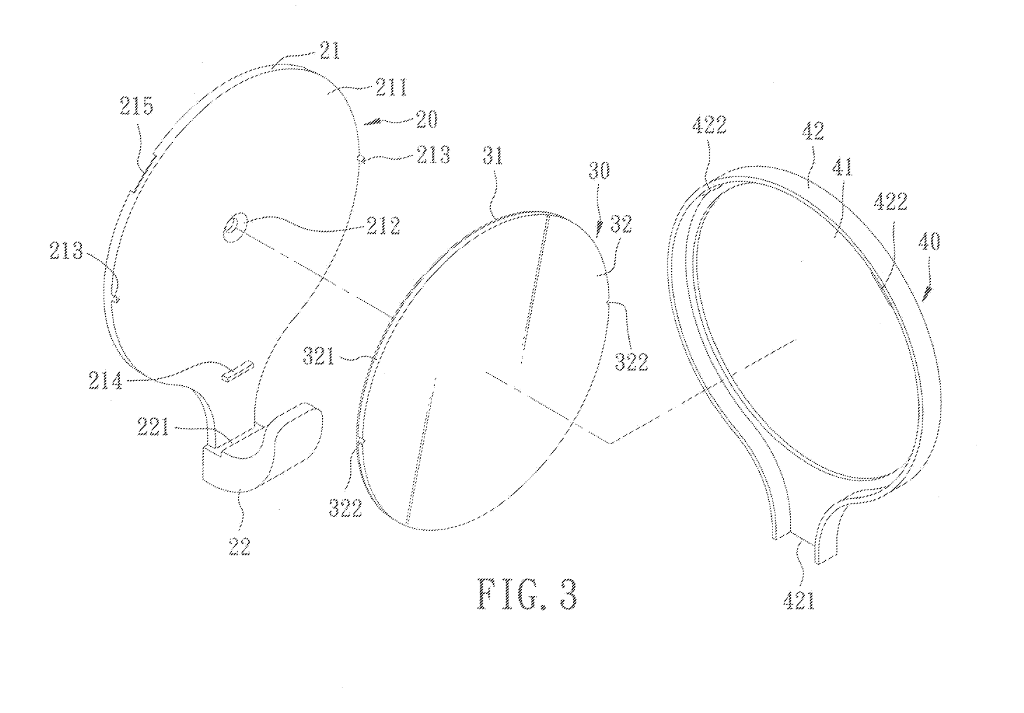

Referring to FIGS. 2 and 3, the preferred embodiment of a hook device according to this invention comprises a hook body 20, a decorative panel 30, and a retaining frame 40.

The hook body 20 has a circular wall mounting portion 21 that has a front mounting surface 211 and a lower end, and a hook portion 22 that extends from the lower end of the wall mounting portion 21. The decorative panel 30 is disposed on the front mounting surface 211, and has a decorative picture 31 and a transparent face plate 32 through which the decorative picture 31 can be viewed. The retaining frame 40 is mounted on the wall mounting portion 21, and has an opening 41 through which the decorative panel 30 can be viewed, and an outer rim 42 capable of securing the decorative panel 30 on the hook body 20.

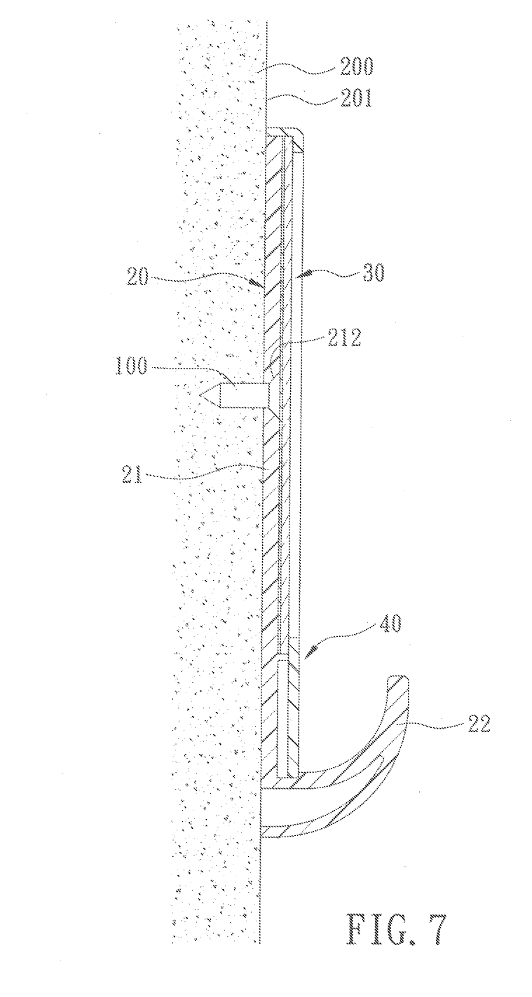

Preferably, the wall mounting portion 21 of the hook body 20 has a fastener hole 212 formed therethrough. In this embodiment, the fastener hole 212 is disposed in the center of the front mounting surface 211. Referring to FIG. 7, a nail 100 can be extended through the fastener hole 212 and driven into a wall 200, so that the hook body 20 is mounted on a surface 201 of the wall 200.

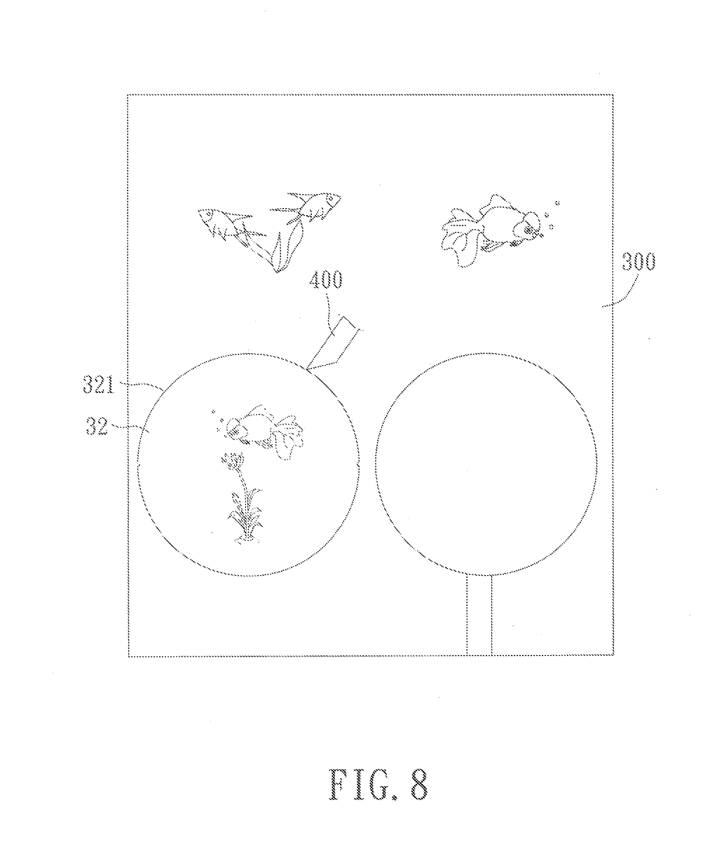

In this embodiment, the picture 31 of the decorative panel 30 can be a manufactured one chosen by a user. The picture 31 can also be one the user has created. Referring to FIG. 8, the picture can be created on a drawing paper 300, and sized for placement on the front mounting surface 211 by placing the transparent face plate 32 over the picture, and using a cutting tool 400 to cut along a rim 321 of the transparent face plate 32.

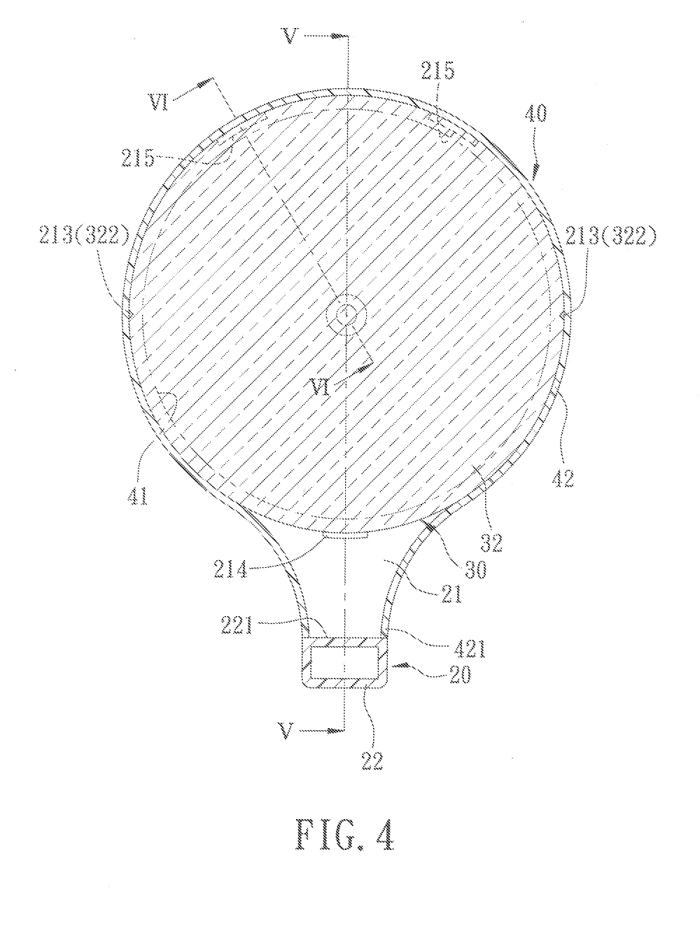

Preferably, the front mounting surface 211 of the wall mounting portion 21 is formed with a protrusion 213 for positioning the decorative panel 30 on the wall mounting portion 21. In this embodiment, a periphery of the front mounting surface 211 is formed with a pair of spaced apart triangular protrusions 213, and a lower portion of the front mounting surface 211 is formed with an arc-shaped protrusion 214 (see FIGS. 3 and 4). The rim 321 of the transparent face plate 32 of the decorative panel 30 is formed with a pair of spaced apart triangular cutout portions 322. A lower portion of the rim 321 of the transparent face plate 32 can be supported by the arc-shaped protrusion 214 of the front mounting surface 211, and the pair of triangular cutout portions 322 of the transparent face plate 32 can engage the pair of triangular protrusions 213 of the front mounting surface 211, thus positioning the decorative panel 30 on the wall mounting portion 21 of the hook body 20.

As previously stated, the retaining frame 40 is mounted on the wall mounting portion 21, and has an opening 41 through which the decorative panel 30 can be viewed, and an outer rim 42 capable of securing the decorative panel 30 on the hook body 20.

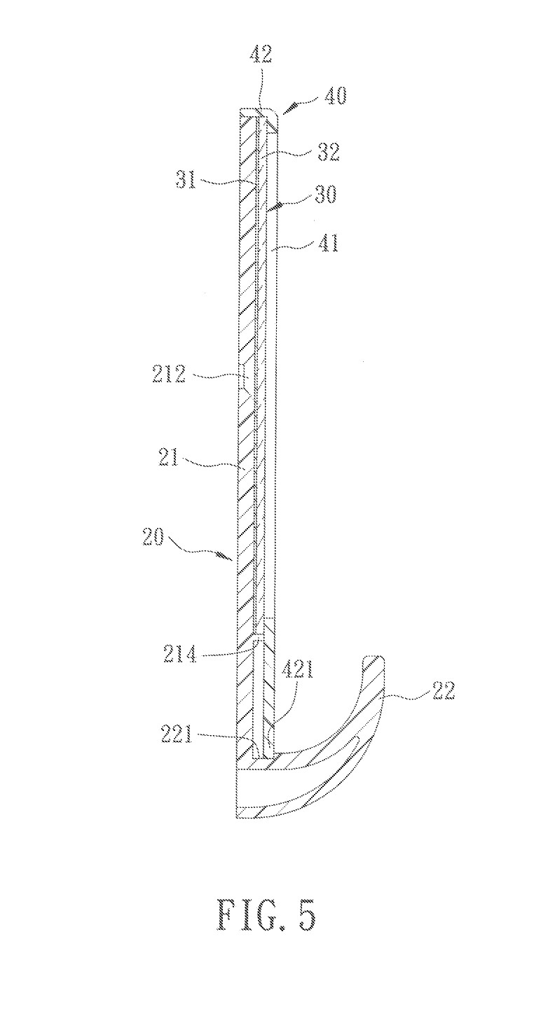

Preferably, the hook body 20 is formed with an engaging groove 221 at a junction of the wall mounting portion 21 and the hook portion 22, and the retaining frame 40 has an edge portion 421 received in the engaging groove 221 so as to present a streamlined appearance (see FIGS. 3, 4 and 5).

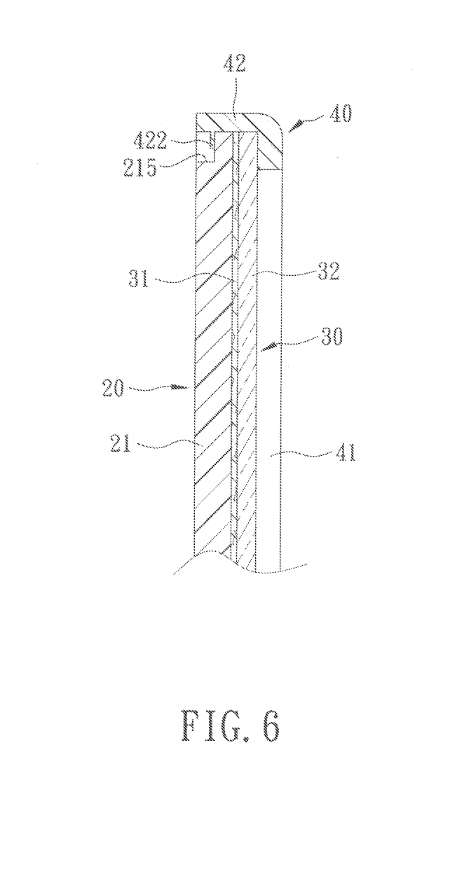

Preferably, the wall mounting portion 21 has a periphery formed with a coupling recess 215, and the outer rim 42 of the retaining frame 40 is formed with a coupling protrusion 422 for engaging removably the coupling recess 215. In this embodiment, the periphery of the wall mounting portion 21 is formed with a pair of spaced apart coupling recesses 215, and the outer rim 42 of the retaining frame 40 is formed with a pair of spaced apart coupling protrusions 422 for engaging removably and respectively the coupling recesses 215 (see FIGS. 3, 4, and 6). Through the removable connection between the retaining frame 40 and the hook body 20, the decorative picture 31 of the decorative panel 30 can be replaced when desired.

It has thus been shown that the hook device of this invention can achieve a greater variety of decorative effects, and that the retaining frame 40 is precisely mounted on the wall mounting portion 21 of the hook body 20, so as to enhance the outer appearance of the hook device.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A hook device, comprising:
a hook body having a wall mounting portion that has a front mounting surface and a lower end, and a hook portion that extends from said lower end of said wall mounting portion;
a decorative panel disposed on said front mounting surface, and having a decorative picture and a transparent face plate through which said decorative picture can be viewed; and
a retaining frame mounted on said wall mounting portion, and having an opening through which said decorative panel can be viewed, and an outer rim capable of securing said decorative panel on said hook body.

2. The hook device as claimed in claim 1, wherein said hook body is formed with an engaging groove at a junction of said wall mounting portion and said hook portion, and said retaining frame has an edge portion received in said engaging groove.

3. The hook device as claimed in claim 1, wherein said front mounting surface of said wall mounting portion is formed with a protrusion for positioning said decorative panel on said wall mounting portion.

4. The hook device as claimed in claim 1, wherein said wall mounting portion of said hook body has a fastener hole formed therethrough.

5. The hook device as claimed in claim 1, wherein said wall mounting portion has a periphery formed with a coupling recess, and said outer rim of said retaining frame is formed with a coupling protrusion for engaging said coupling recess.
